(19) United States
(12) Patent Application Publication
(10) Pub. No.: US 2026/0278351 A1
(43) Pub. Date: Sep. 17, 2026

(54) Accelerating SoftMax with Mixed Precision Operations

(71) Applicant: NVIDIA CORPORATION, Santa Clara, CA (US)

(72) Inventors: Robert Ohannessian, Jr., Santa Clara, CA (US); Matthew Ashcraft, Santa Clara, CA (US); Brent Boswell, Santa Clara, CA (US); Ilyas Elkin, Santa Clara, CA (US); Jian Liu, Santa Clara, CA (US); Ming Yiu Siu, Santa Clara, CA (US); Cherin Joseph, Santa, CA (US); Ajay Sudarshan Tirumala, Santa Clara, CA (US); Chao Zhou, Santa Clara, CA (US); Elliot Liu, Santa Clara, CA (US)

(21) Appl. No.: 19/557,409

(22) Filed: Mar. 5, 2026

Related U.S. Application Data
(60) Provisional application No. 63/773,396, filed on Mar. 17, 2025.

(51) Int. Cl. G06N 3/048; G06F 7/485; G06F 7/487

(52) U.S. Cl. CPC G06N 3/048; G06F 7/485; G06F 7/4873

(57) ABSTRACT

Hardware-accelerated fused mixed precision floating point instructions include built-in precision conversion capabilities to eliminate overhead associated with switching between precisions. Such mixed precision operations that can be used to accelerate probability distribution function operations like SoftMax and Flash Attention, and/or for accelerated conversion to MX microscaling formats in other contexts. Using the new mixed precision instructions reduces the instruction count in half in example SoftMax/Flash Attention implementations.

### CROSS-REFERENCE TO RELATED APPLICATION

Benefit is claimed from U.S. Provisional Patent Application No. 63/773,396 filed Mar. 17, 2025 entitled “Accelerating SoftMax with Mixed Precision Operations”, incorporated herein by reference in its entirety as if expressly set forth.

### FIELD

The technology herein relates to hardware computation circuitry in high performance computing devices including but not limited to Parallel Processing Units (PPUs) and Graphics Processing Units (GPUs). Still more particularly, technology herein relates to high performance mixed precision floating point hardware computation circuits, associated application programming interfaces (APIs), and instruction set architecture (“ISAs”). The technology herein further relates to rapidly and efficiently using mixed floating point precision to compute probability distribution functions including but not limited to SoftMax/Flash Attention functions for use with Neural Networks and deep learning hardware processors.

### BACKGROUND & SUMMARY

Modern high performance graphics processing unit (GPU) hardware is able to efficiently and rapidly perform extremely complex high precision computations—paving the way for many useful applications including machine learning and artificial intelligence.

For example, training a neural network (NN)(the current foundational technology of commonly implemented artificial intelligence) typically involves using matrix multiplication to multiply a matrix of coefficients (“weights”) by a matrix of input values. Matrix multiplication is thus a core operation for deep learning and scientific computing applications.

Just as an egg carton contains a two-dimensional array of eggs, a numerical matrix stored inside a computer contains a two-dimensional array or “matrix” of values. (note: data storage in processors is not exactly in 2 dimensions, it's a bit more complex with cache-line sizes, offsets, etc. It's just that the matrix multiply instructions we design are logically 2 dimensional matrices). We all learned how to multiply two numbers together to produce a third number. Two matrices (“matrices” is the plural of “matrix”) of numbers can also be multiplied together, that is, by taking the inner product of vectors in the first matrix by vectors in the second matrix:

$$A * B = C .$$

Modern high performance parallel processing units (PPUs) such as GPUs contain hardware for accelerating (speeding up) commonly-used parallel compute operations. NVIDIA GPUs for example have specially designed tensor core (TC) hardware that implements matrix-matrix operations as described above. The tensor core hardware is designed and supported so different tensor cores can operate in parallel on different parts of large matrices.

The tensor cores comprise individual hardware calculator circuits such as multipliers, adders, shifters, comparators, multiplexers, and combinatorial logic (see FIGS. 1 & 1A) that perform calculations in response to instructions or commands (API calls) that software running on a processor or other controller issue via an application program interface (API). Such tensor core hardware implements a matrix-matrix (or matrix-vector) operation called matrix-multiply-accumulate (MMA), which is a fundamental building block for many operations in neural networks and other applications. See e.g., “Matrix Multiplication Background User's Guide”, NVIDIA (2023), available at docs.nvidia.com/deeplearning/performance/dl-performance-matrix-multiplication/index.html. This is shown within the FIG. 1A block labelled “TC” for “Tensor Core”. MMA is a hardware primitive that multiplies and adds (accumulates) in single, high-speed hardware computations with only one rounding, i.e., D=A*B+C, where each element is a matrix. The MMA operation may typically be implemented by many parallel fused multiply-add (“FMA”) operations per core per clock cycle. See e.g., IEEE 754-2008 (2008) for floating-point arithmetic. Such hardware implementations compute dot products of vectors as a sub-operation to computing the matrix-matrix (or matrix-vector) multiplies of the MMA.

The accumulated result of the MMA operation may then be further operated on using additional instructions (and potentially other ALU hardware) that remove bias, and/or to convert the result to a lower floating point precision (e.g., to reduce the precision of a floating point 32 result to floating point 16, floating point 8, bfloat 16, etc.).

This fused “MMA” operation which multiplies as well as adds, illustrated in FIG. 1A, is faster and more accurate than performing multiplication and addition steps separately. For more on such instruction fusing, see e.g., Singh et al, “Exploring Instruction Fusion Opportunities in General Purpose Processors,” 2022 55th IEEE/ACM International Symposium on Microarchitecture (MICRO), Chicago, IL, USA, pp. 199-212 (2022), doi: 10.1109/MICRO56248.2022.00026; Quach et al, “Suggestions For Implementing A Fast IEEE Multiply-Add-Fused Instruction”, Technical Report: CSL-TR-91-483 (Stanford University July 1991); US20080184211; US20090150654; U.S. Pat. Nos. 8,037,119; 8,051,123; 8,140,608; 8,190,669; 9,465,578; 10,338,919; 11,816,482; 11,080,051.

### The SoftMax Function

When used for neural networks, such MMA operations are often implemented along with SoftMax, a well-known helper function frequently used as a probabilistic link function for unordered categorical data. In simple terms, SoftMax transforms raw scores into probabilities. SoftMax is used at the outputs of many classification neural networks to convert raw outputs into class probabilities, i.e., a set of values between 0 and 1 that add up to 1. For example, SoftMax can convert the raw output “A has a score of 206.3” into something like “there is a 70% chance of A.” The value “206.3” may have no clear meaning without additional context or scaling, whereas “70% probability” can be more directly interpretable as how likely each outcome is on a 0 to 100% scale.

The SoftMax function defines a mapping that takes a vector of scores S=(s1;:::;sn) and maps it to a vector of corresponding probabilities p=(p1;:::;pn), using the SoftMax (optimality) parameter to modulate the shape of the output distribution p. Given n discrete outcome categories x=(x1, . . . , xn), the SoftMax model predicts how likely each category xi is. The form of the SoftMax function is the same as Boltzmann's distribution formulated long ago by physicist Ludwig Boltzmann to describe the probability of a system being in a certain state based on its energy and temperature. John S. Bridle in a 1989 paper coined the term “SoftMax” and showed how to use the function to provide a probabilistic interpretation of feedforward neural network outputs for classification. More recently, SoftMax has turned out to be one of the key stages of dominant neural network architectures including for example recurrent NNs, convolutional NNs and transformer NNs. Many such neural network computation architectures make extensive use of MMA, and SoftMax (and quantization) is often used between or after MMA operations to normalize data.

Typically, the output of an MMA implementing a neural network (NN) is a matrix of raw, unnormalized attention scores sometimes referred to as “logits”. SoftMax can be used to convert these “logits” from a linear transformation to a probability distribution over classes, which is helpful for classification by the NN. See e.g., Franke et al, “The SoftMax function: Properties, motivation, and interpretation”, doi.org/10.31234/osf.io/vsw47 (2023); youtu.be/ytbYRIN0N4g?feature=shared; docs.nvidia.com/deeplearning/tensorrt-rtx/latest/_static/operators/SoftMax.html;

docs.nvidia.com/deeplearning/transformer-engine/user-guide/api/c/Softmax.html.

Many neural networks use attention weights, which can be interpreted as the probability or importance of each input token relative to every other token. Simple example: Suppose the model is asked to parse a sentence like “The cat sat on the mat.” The model needs to know which other words are most relevant to the action word “sat.” Important words like “cat” and “mat” receive high weights because they provide necessary context for the action “sat”. Less relevant words like “the” receive weights closer to zero.

SoftMax can be applied to produce such attention weights on a probability distribution of 0 to 1, making the values more interpretable. The SoftMax output ensures the probability distribution is valid and thus that the NN model weighs the input tokens in a coherent and interpretable way. SoftMax is also differentiable, which is useful for training neural networks with backpropagation. This allows the NN model to learn and adjust parameters more effectively.

As is well known, the SoftMax function can be expressed mathematically as:

$${σ ( z )}_{i} = \frac{{e}^{{z}_{i}}}{{\sum }_{j = 1}^{K} {e}^{{z}_{j}}} .$$

SoftMax(x) can also be expressed as SoftMax(x−α) where α is a bias or constant. In particular, SoftMax(x−a)==SoftMax(x)(there is no bias in the result, no matter what the value of ‘a’ is). In this context, it is desirable to find the maximum probability value xi and subtract it out in order to increase stability (in fp32, ex can otherwise easily end up as infinity). SoftMax can be implemented by electronic circuitry and/or by a processor performing a series of operations such as calculation steps. See e.g., US20240160406 and Frank et al.

### Quantization

In computer technology, quantizing is often used to convert higher precision numerical representations to lower precision representations. Quantization can be thought of as “rounding” to the closest interval. You may not have thought of it this way, but when you round your restaurant bill including the tip to the nearest dollar, you are “quantizing.” In digital hardware calculation contexts, quantization often involves reducing the bit-precision of values (e.g., from 32-bit floating-point to 16-bit floating point or even to 8-bit or 4-bit integers). See “Note: A Word About Floating Point and Precision” at the end of this specification for more information.

One might think that it would be advantageous to perform all computations and maintain all results at high precision. While often true in the abstract, high precision computations generally require more complicated hardware and/or more time to complete, and high precision results require more storage to store and more bandwidth to transfer. Choice of numerical precision thus trades off computation result precision against required hardware complexity, amount of required storage, computation time, and energy utilization.

For example, in order to avoid classification errors, all input-to-output operations inside SoftMax have typically or traditionally been performed in high precision (e.g., 32-bit floating point (“fp32”) at the present time). Because of how long high precision hardware takes to perform these calculations, SoftMax operations can become the performance limiter for DL (deep-learning) workloads. In some cases, the fp32 SoftMax operations can take longer to perform than the MMAs.

Quantizing between MMA operations enables lower precision arithmetic-which can mean less hardware and/or less calculation time. But SoftMax is highly sensitive to quantization. For example, quantization can cause SoftMax to round its output probabilities down to zero. Because of these rounding errors, the output probabilities may no longer sum to 1. This creates a “quantization bias” that can significantly degrade model accuracy. To prevent such quantization bias, the SoftMax layer is sometimes kept at a higher precision (or unquantized) to avoid degradation. Bias correction techniques have also been developed to compensate for this “SoftMax bias” and restore normalization.

However, as MMA hardware gets faster from generation to generation, more and more workloads become limited by the performance of SoftMax and quantization operations. Many commonly used DL algorithms, including SoftMax and “Flash Attention” and related probability calculation algorithms, are now being degraded by slow performance.

### Attention & Flash Attention

“Attention” is a mechanism that allows a transformer NN model to dynamically focus on different parts of the input sequence when producing each element of the output sequence. Attention works by using SoftMax to compute attention scores between input components to weight the importance of each token relative to others. This allows the NN model to capture long-range dependencies and context within the input instead of just processing each token independently, one at a time.

The standard attention mechanism has quadratic time and memory complexity in sequence length and can present significant runtime and memory challenges for longer sequences. “Flash Attention” is an efficient way to compute the attention operation in transformer models that keeps the result exact while greatly reducing GPU memory traffic and speeding up training and interference. “Flash attention” is an improved attention procedure that allows breaking down the problem into chunks that can be independently computed by parallel or other processing units (like the SM) and combine it later. It does this by restructuring the attention computation so it processes queries, keys and values in small tiles that fit in fast on-chip memories of plural processors. It thus makes better memory locality for the individual processing elements, and also greatly extends the range of sequence length allowed.

Flash attention reduces memory bandwidth requirements to eliminate the memory access bottleneck typically suffered by attention implementations, e.g. by (a) computing SoftMax reduction without access to full input, and (b) implementing backward passes without needing the large attention matrix from forward passes. Flash attention uses the same key operations (ex, accumulation, subtraction, etc.) as SoftMax but in slightly different combinations. Flash attention meanwhile presents a challenge to accelerate in both forward and backward passes.

FIG. 2 shows a prior art example Flash Attention procedure using SoftMax, and FIG. 3 shows additional detail. As shown in FIGS. 2 & 3, Flash Attention loads block by block from main GPU memory to SRAM to compute attention, and recomputes the attention matrix in the backward pass instead of storing the (possibly quite large) attention matrix from the forward pass. One preferred implementation is a fused CUDA kernel for fine-grained control of memory accesses. With Flash Attention, the memory usage grows linearly with sequence length instead of quadratically—making Flash Attention scalable.

As an improvement over the standard attention mechanism's use of SoftMax, Flash Attention uses sum associativity—breaking apart the SoftMax into two different stages and reordering the stages with some other calculations. In particular, Flash Attention includes a recomputation technique that stores SoftMax normalization factors (linear to sequence length), instead of SoftMax results (quadratic to sequence length), and uses these normalization factors to recompute attention scores. See FIGS. 2 & 3. In Flash Attention, SoftMax still produces a probability distribution, but the way Flash Attention implements SoftMax saves the amount of data to write to global memory and reduces both the memory requirement and input/output (I/O) traffic between global memory and shared memory.

For more information on Flash Attention, see for example docs.nvidia.com/nemo-framework/user-guide/24.09/nemotoolkit/features/optimizations/attention_optimizations.html; Dao et al, Flash Attention: Fast and Memory-Efficient Exact Attention with IO-Awareness (Jun. 24, 2022) doi.org/10.48550/arXiv.2205.14135; docs.nvidia.com/deeplearning/cudnn/archives/cudnn-897/developer-guide/index.html #flash-fused-multi-head-att-fprop; neurips.cc/virtual/2022/poster/54008; ee e.g., Dao et al, Flash Attention: Fast and Memory-Efficient Exact Attention with IO-Awareness (2023), //tridao.me/publications/flash2/flash2.pdf.

### Improving Performance of SoftMax & Flash Attention

In current CUDA Flash Attention and SoftMax implementations, the next bottleneck is the issue of fp32 limit. Typical current implementations use many fp32 instructions such as FMNMX (fp32 minimum/maximum), FADD (fp32 add) & FMUL (fp32 multiply). See e.g., CUDA Binary Utilities v13.1 (Jan. 8, 2026 and previous archival versions) published at “cuda-binary-utilities Release 13.1” (NVIDIA Corporation Jan. 8, 2026), available at docs.nvidia.com/cuda/cuda-binary-utilities/index.html and FIG. 11. While it is possible to move the FMNMX (fp32 minimum/maximum) instruction into LDTM.STAT (Load Matrix from Tensor Memory to Register File), the result would still be fp32 FADD/FMUL-limited. More innovation is needed to remove this limitation.

By way of example, FIG. 11 shows instructions for a legacy instruction SoftMax implementation (and Flash Attention, by extension). We want to compute the difference between each element and the max element, and then scale by l/ln (2) to compute the exponential. In the FIG. 11 example, these are 2 separate multiply/add instructions which together compute:

$$( x\_i - max ) * ( 1 / ln ( 2 ) )$$

Example Current SoftMax Performance Modeling (referring again to FIG. 11 showing the legacy instruction SoftMax implementation):
n=block size
Max of input values: (LDTM.STAT)
Exponent deltas: n instructions (FADD)
Exponent exp pre-scale: n instructions (FMUL)
Numerator: n instructions (MUFU)(FP32 Multi Function Operation)
Denominator: n instructions (1 MUFU+n−1 FADD)
Ratio: n instructions (FMUL)
Quantization component scaling: ~n instructions (FMUL)
Quantization conversion: n/2 instructions (F2FP)(FP32 Down-convert and Pack)
Total: ~6.5 n instructions
Further Improvement: Use of FMA Instruction

As noted above, 2 separate multiply/add instructions can be used to together compute:

$$( \begin{matrix}x\_i & max\end{matrix} ) * ( 1 / ln ( 2 ) )$$

Mathematically, this is the same as:

$$( x\_i * 1 / ln ( 2 ) ) - ( max * 1 / ln ( 2 ) )$$

Since there is only 1 max value, we can compute the last part of that equation just once, and then treat it like some constant “C” for each element:

$$( x\_i * 1 / ln ( 2 ) ) - C$$

The above can theoretically be implemented as a single FMA instruction. However, as explained in detail below, there are practical complications.

In an attempt to overcome the various challenges described above, prior solutions improved SoftMax and quantization performance by using either vector instructions to reduce issue bandwidth (but these did not reduce execution throughput nor register file (RF) bandwidth however) or switched SoftMax wholesale from 32-bit floating point (fp32) to a lower precision such as 16-bit floating point (fp16). As one such example, see US20220067513, which used a reduced-precision implementation of various operations in SoftMax, replacing ex with 2× to reduce instruction overhead associated with computing exponentials, and replacing floating point max computation with integer max computation. See also U.S. Pat. No. 12,299,577 disclosing a low precision tensor processing format.

Additionally, there has generally been a drive to use smaller precision (microscaling or MX-compliant) formats to enable Artificial Intelligence (AI) training and inference with lower bit-width arithmetic operations and smaller memory footprints. This drives hardware performance and efficiency gains that can reduce overheads and operational costs including energy demands. Useful and convenient ways to convert between higher precision formats and MX compliant formats are now in demand.

### BRIEF DESCRIPTION OF THE DRAWINGS

FIG. 1 is a prior art block diagram of a streaming multiprocessor including floating point arithmetic logic units and tensor cores.

FIG. 1A shows a prior art tensor core matrix multiply and accumulate operation.

FIG. 2 is a prior art block diagram showing Flash Attention operations including SoftMax.

FIG. 3 is prior art block diagram showing operations used by a Flash Attention implementation.

FIG. 4 is a block diagram of example GPU “streaming multiprocessor” (SM) hardware including fused mixed precision floating point calculation circuitry.

FIG. 5A shows a prior art sequence of a calculation instruction/operation in response to a first instruction call followed by a conversion instruction/operation in response to a second instruction call.

FIG. 5B shows a new fused mixed precision floating point instruction that performs the calculation instruction/operation and a conversion instruction/operation in response to a single instruction call.

FIG. 6 shows an analysis of a FIG. 11 SoftMax routine for what can be performed at reduced precision.

FIG. 7 is a flowchart of an example SoftMax implementation using fused mixed precision floating point instructions such as FHADD2.

FIG. 8 shows an example SoftMax calculation pseudocode using fused mixed precision floating point instructions.

FIG. 9 is a block circuit diagram showing an example hardware calculation circuit pipeline supporting the operations of FIGS. 7 & 8.

FIG. 10 shows example prior art floating point formats.

FIG. 11 shows for comparison, an example SoftMax calculation that does not use mixed precision floating point operations.

FIG. 12 shows an example fused F2FP instruction processing circuit.

FIG. 13 shows an example operation sequence for a fused F2FP instruction.

FIG. 14 is an example block diagram showing F2FP fused instructions interleaved with matrix multiplication and SoftMax operations.

FIG. 15 shows an example processing system using mixed precision floating point instructions and associated operations.

FIG. 16 shows an example fused mixed precision arithmetic logic circuit.

### DETAILED DESCRIPTION OF EXAMPLE NON-LIMITING EMBODIMENTS

### Technical Solution

As noted above, there are disadvantages and technical challenges to trying to perform all of SoftMax in lower precision. The example technology herein provides a novel solution of performing different parts of the SoftMax operation in different precisions, and using a new fused instruction mechanism to efficiently switch between precisions.

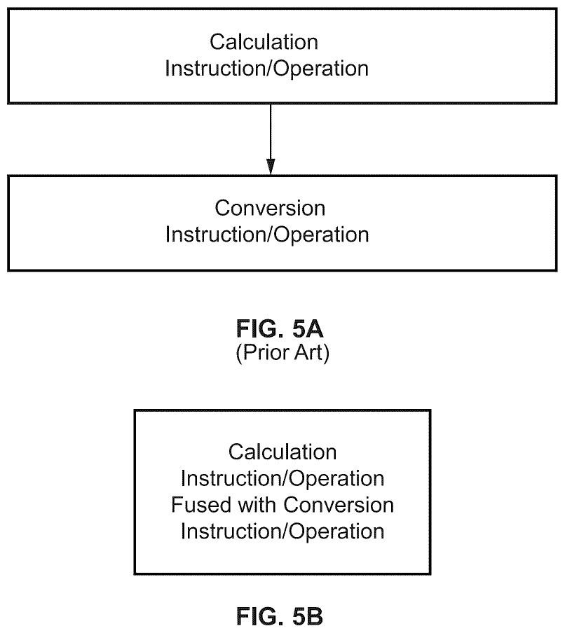

Use of different precisions for intermediate calculations within SoftMax or other similar probability distribution calculations is known to add a lot of overhead. As indicated in FIG. 5A, it generally introduces the need to execute additional prolog conversion instructions to convert from higher precision to lower precision before doing a lower precision calculation, and/or additional epilog conversion instructions after performing the lower precision calculation to convert from lower precision to higher precision. The need to execute such prolog and/or epilog conversion instructions have the potential to erase performance gains that may be realized by performing some SoftMax calculations in lower precision.

For example, implementing SoftMax with fp32 instructions where needed and then using additional, separate, prior art legacy conversion instructions to convert from fp32 to fp16 before resuming processing in fp16 for other SoftMax internal processes, could take longer than running SoftMax entirely in fp32. In other words, the overhead associated with converting from one precision/format to another may substantially erase any performance gains realized by performing calculations at lower precision.

Example embodiments avoid or eliminate such typical format conversion penalties.

### Introducing New Fused “Mixed Precision Floating Point” Instructions

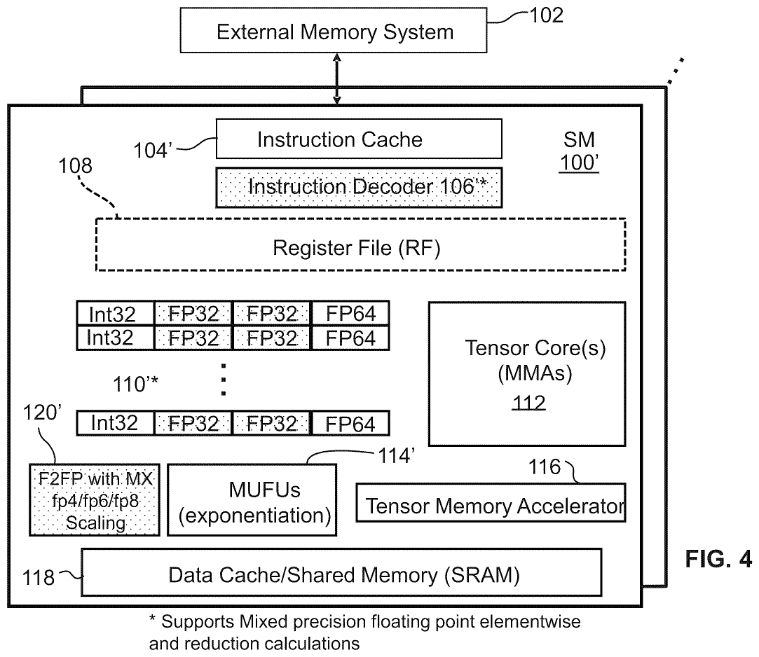

As illustrated in FIGS. 4 and 5B, example embodiments provide hardware circuits, other computation units, and associated instruction APIs within an instruction set architecture (ISA), that can be used e.g., to perform many functions including but not limited to Flash Attention and SoftMax, using new fused “mixed precision floating point” instructions. Using such new instructions within a given procedure such as SoftMax or Flash Attention can provide benefits such as:
intermediate formats can have lower precision (thereby reducing calculation time), and
instructions natively take one format as input and produce a different output format, minimizing use of or need for additional overhead instructions to convert from one precision to another precision.

In example embodiments as FIG. 5B indicates, with such fused “mixed precision floating point” operations/instructions, the same operation/instruction based on a single microinstruction call having a single op code and a single set of parameters stored at a single memory address, both (a) performs a desired calculation such as multiplication or addition to yield a first precision/format, and (b) converts the result from the first precision/format to a second precision/format different from the first precision/format, all in one hardware cycle or set of hardware cycles associated with a single instruction execution period.

Such fused “mixed precision floating point” operations/instructions thus enable use of different (e.g., lower) precision calculations to produce intermediate (internal) results that are of different (e.g., lower) precision(s), without requiring issuance of additional overhead instructions just or only to convert from one precision/format to another precision/format (e.g., from a higher input precision to a lower intermediate precision, or from a lower intermediate precision to a higher output precision, and/or from one format to another format).

Example embodiments provide two independent mechanisms:
mixed precision (32-bit/16-bit) operations that can be used to accelerate operations like SoftMax and Flash Attention, and
accelerated conversion to MX microscaling formats.

These two independent mechanisms work well together in a sequence such as matrix multiply (whatever input format)→mixed precision SoftMax→convert to MX→MX input matrix multiply but they also work well independently, for example:
Matrix multiply→FP32 operation (SoftMax or something else)→convert to MX→MX input matrix multiply
OR
Matrix multiply→mixed precision SoftMax→16-bit precision input matrix multiply.

All three combinations are valid application choices a user could choose. Example embodiments make sure the two mechanisms fit well together so that a user can use the two in series, but it isn't a requirement.

Meanwhile, individual fused mixed precision floating point operations/instructions may be distinctive in and of themselves, and power and advantages may come from combining plural or several such fused mixed precision floating point operations/instructions together (e.g., in combination with legacy instructions) in the same execution sequence in implementing distribution function calculations including but not limited to SoftMax and Flash Attention. Furthermore, example embodiments provide carefully designed fused mixed precision floating point instructions that minimize impact to hardware design by reducing area on a chip semiconductor wafer needed for hardware circuitry (e.g., within arithmetic logic unit circuitry) used to perform these instructions. In one example embodiment, foundation calculations (e.g., floating point multiply/divide, floating point add/subtract, convert from one precision/format to another, etc.) the new fused mixed precision floating point instructions perform may be mostly or entirely preexisting, but they are “fused” with trailing precision conversion options that can dramatically increase efficiency in certain contexts such as SoftMax without the overhead of calling additional instructions to perform the conversion.

A new hardware implementation of these new operations/instructions adds a new decoder and new internal combinatorial control logic in the data path (see FIG. 4 stippled boxes). Mixed precision floating point formats benefit from aligning and adjusting exponents differently for the mixed formats, e.g., such as configuring multiplexer selectors differently than in past designs. The more major data paths such as addition, multiplication and conversion can be preexisting and may require no modification, but when fusing floating point addition or floating point multiplication with conversion, associated data paths for e.g., addition and conversion are now connected and realigned together whereas before they were separate.

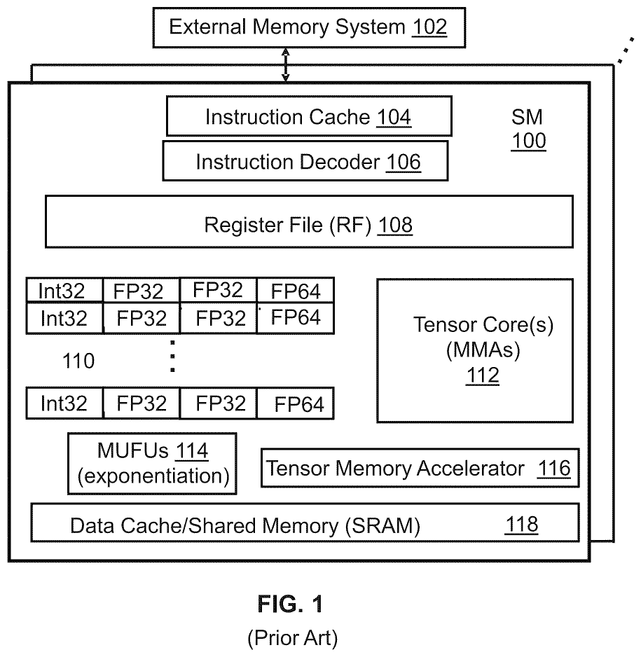

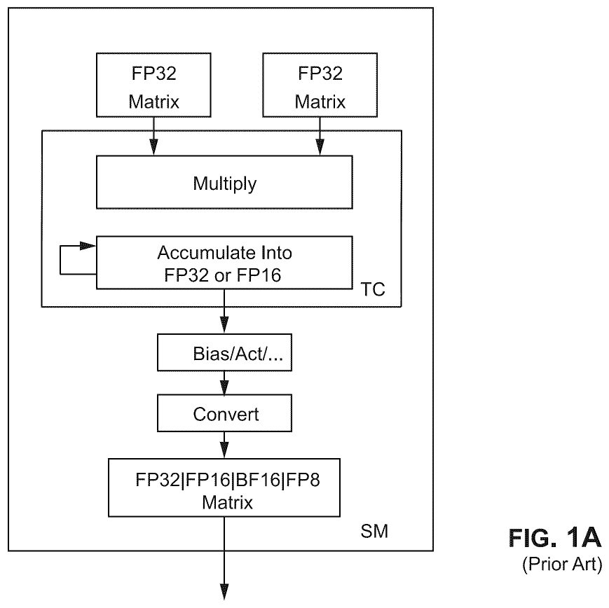

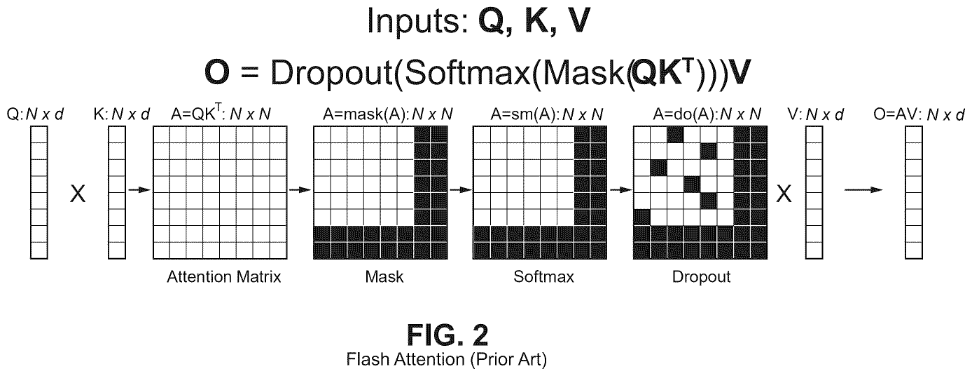

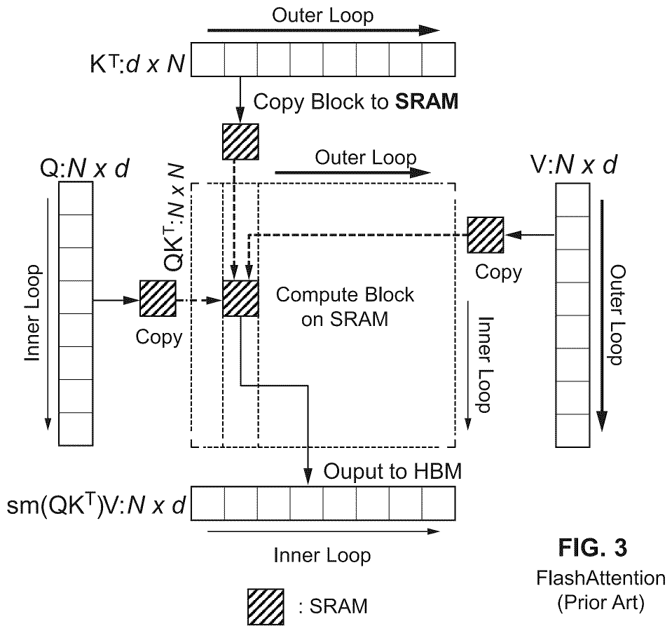

In more detail, FIG. 4 is a block diagram of an example streaming multiprocessor 100′ providing support for the operations herein including new fused floating point instructions as described below. Comparing FIG. 4 with prior art FIG. 1, one can see that the basic structure of the streaming multiprocessor (SM) 100′ is the same, but crosshatching on FIG. 4 is used to indicate portions which are new or modified. As shown in FIG. 4, in example embodiments of the present technology, a streaming multiprocessor 100′ or other processing core includes an instruction cache 104, an instruction decoder circuit 106′, a register file circuit 108, an arithmetic logic unit (ALU) circuit(s) 110′, a tensor core(s) circuit 112, multifunction unit(s)(MUFU) computation circuits 114, a tensor memory accelerator circuit 116, a data cache/shared memory circuit 118, and a computation block circuit 120′ providing fused F2FP with microscaling (“MX”) fp4/fp6/fp8 Scaling. An external memory system 102 supplies instructions to on-chip instruction cache 104′. These instructions (including new fused instructions) defined as part of an instruction set architecture (ISA) are decoded by instruction decoder 106′, which generates control signals for controlling the combinatorial logic and other components of the SM 100′. For example, the instruction decoder 106′ controls and parameterizes floating point calculation and manipulation portions of ALU 110′ to perform calculations specified by the instructions the instruction decoder 106 decodes. The instruction decoder 106′ also parameterizes and controls the MUFUs 114 and new block 120′ to perform functions as described herein based on instructions the instruction decoder decodes. Instruction decoder 106′ also generates control signals and parameters that control tensor core(s) 112 to perform matrix operations. Results of such calculations are stored in specified registers within register file 108′ and/or data cache/shared memory (SRAM) 118.

In some implementations, the register file 108 is implemented as part of data cache/shared memory 118, but the register file is here shown conceptually in dotted lines as being separate. Also not shown for simplicity are flow control (program counter, etc.) mechanisms, inter-SMs 100′ communications, and numerous other well-known circuits that enable the SM to “execute” threads and thread groups (i.e., software programs) and synchronize its operation with other SMs.

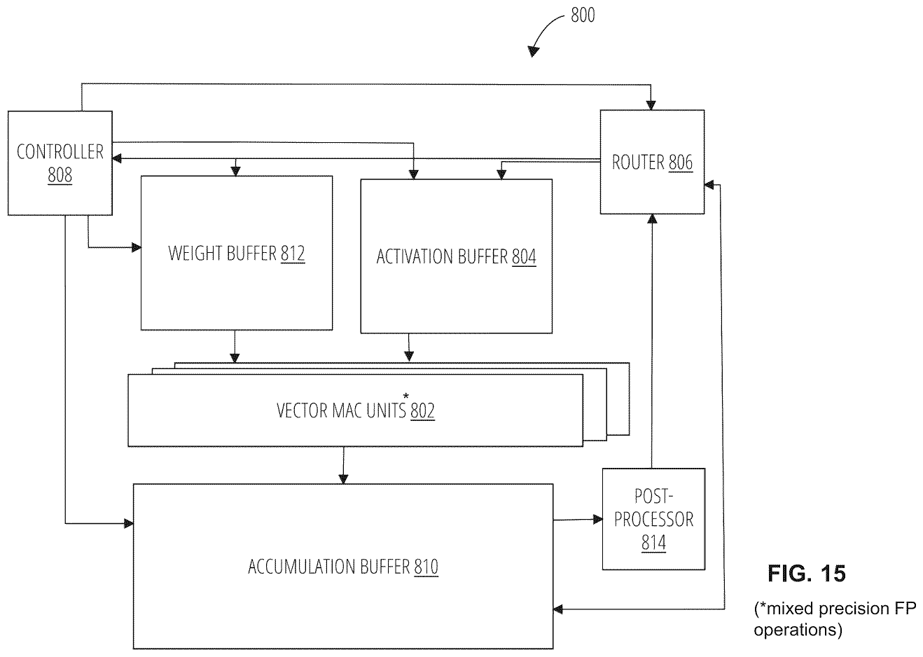

In example embodiments, the SM 100′ architecture shown in FIG. 4 thus natively supports, decodes, implements and performs in hardware circuitry, all instructions described in this specification—including new fused mixed precision floating point operations/instructions described herein. The stippled portions of FIG. 4 (instruction decoder 106′, 32-bit floating point portions of ALU 110′, and the F2FP computation block 120′) show particular circuits added to or modified from the prior art FIG. 1 implementation to support new fused mixed precision floating point operations/instructions. The FIG. 4 architecture meanwhile is the basic processing entity for more complex systems such as described below in connection with FIGS. 15 & 16. In a modern GPU parallel processing system, there are or may be hundreds or thousands of such SMs 100′ operating in parallel, for example with each SM assigned to operate on a particular block or tile of a potentially huge data structure(s) such as matrix or matrices. Such concurrent operations enable even high dimensional problem sets to be performed relatively rapidly and efficiently. Goals of the present technology are to increase the efficiency and speed by enhancing hardware acceleration of new operations/instructions.

One aspect provides a neural network processor comprising: a hardware calculator that receives a vector of logits; exponentiates each element of the vector; sums exponentiated values to provide a sum; and divides each exponentiated element by the sum to produce a probability distribution of results each of which are between 0 and 1 and all of which together sum to 1, wherein the hardware calculator includes a hardware instruction decoder configured to decode a single instruction call controlling hardware to (a) compute a value in first precision floating point and (b) convert the computed first precision floating point value to a second precision floating point value having a second floating point precision different than the first precision floating point.

The hardware instruction decoder is configured to decode one of (a) a mixed precision addition/subtraction operation code, or (b) a mixed precision multiply operation code, or (c) a mixed precision multiply-add operation code, configured to compute a single precision floating point value and convert the single precision floating point value to a half precision floating point value.

Another aspects provides a hardware microinstruction decoder configured to decode a single instruction that performs an operation on results of a first math instruction at a first floating point fixed precision and converts the results to a second floating point fixed precision less than the first floating point fixed precision.

A further aspect provides a processing circuit comprising: an arithmetic logic circuit configured to produce a floating point difference by performing a subtraction based on a first floating point operand at a first floating point precision; a floating point precision converting circuit connected to the arithmetic logic circuit and configured to convert the floating point difference to a second floating point precision difference having a second floating point precision different from the first floating point precision; and a storage connected to the floating point precision converting circuit and configured to pack the second floating point precision difference with at least one other floating point value in a packed storage format, wherein the processing circuit is configured to perform both the subtraction and the floating point precision conversion in response to a single instruction.

The second floating point precision is fp16 or bf16 or fp8 or fp6 or fp4.

The second floating point precision is no more than half of the first floating point precision.

A scaling circuit connected to the floating point precision converting circuit and/or the storage and configured to scale the packed precision-converted differences; an exponentiation circuit connected to the scaling circuit and/or the storage and configured to apply an exponential operation to the scaled precision-converted differences to produce results at the first floating point precision; and a summer connected to the exponentiation circuit and/or the storage and configured to sum results the exponentiation circuit produces to generate a sum at the first floating point precision.

A divider circuit is connected to receive the sum and to calculate exponent reciprocals of the sum at the second floating point precision.

A quantizing circuit configured to quantize pairs of calculated exponent reciprocals to provide reduced floating point precision results.

A further scaling circuit is configured to reduce precision of the calculated exponent reciprocals to a third floating point precision less than the first floating point precision and less than the second floating point precision.

The arithmetic logic circuit is configured to flush output subnormals to 0.

A further aspect provides an instruction decoder configuring arithmetic logic circuitry to calculate probability distribution function parameters, the instruction decoder configured to perform operations comprising: decode a first fused floating point instruction commanding (a) computation of a delta between each floating point value of a probability distribution function input data block at a first floating point precision and a maximum value of the input data block at the first floating point precision, (b) conversion of computed deltas to a second floating point precision different from the first floating point precision, and (c) packing converted computed deltas pairwise; and decode a second fused floating point instruction commanding scaling by a specified exponential-only scaling factor to produce floating point values divided by the specified exponential-only scaling factor and further converted to a reduced precision.

The probability distribution function comprises SoftMax and/or Flash Attention.

The second floating point precision comprises fp16 or bf16 or fp8 or fp6 or fp4.

The instruction decoder is further configured to decode an instruction that sums two parallel accumulators with two exponentials of the second floating point precision.

A further aspect provides computing circuitry comprising an input circuit configured to accept first and second input values and an input scale factor in exponent format; and a scaling/dividing circuit that divides the first and second input values by the input scale factor in exponent format and then converts scaled outputs into a narrower format, wherein the input circuit and the scaling/dividing circuit both operate in response to the same single instruction call.

The scaling/dividing circuit is configured to flush input subnormals.

The scaling/dividing circuit is configured to selectively perform block quantization to a selected one of microscaling FP4/FP6/FP8 formats based on parameters of the same instruction.

The exponent format is E8.

A matrix multiplication circuit is configured to perform a matrix-multiply-accumulate operation on the converted quotients.

The input scale factor is factored out as a common scaling factor from a set of operands.

An output circuit packs the converted quotients such that the computing circuit fuses the division by the input scaling factor with conversion to the narrower format(s) in the single instruction.

The scaling/divider circuit generates outputs with different exponents.

A further aspect provides a method performed by at least one processor accelerated by hardware circuits, comprising: commanding, with a first fused mixed precision floating point instruction call, computing deltas between each value of an input data block and a maximum value of the input data block, converting resulting differences into a reduced precision, and storing the resulting differences in a packed format; commanding, with a second instruction call, exponentiation by scaling the stored resulting differences; commanding, with a third instruction call, applying two to the power of x function to produce exponentials; commanding, with a fourth, fused mixed precision instruction call, summing the exponentials to produce a sum; commanding, with a fifth instruction call, reciprocating the summed exponentials to form a denominator; and commanding, with a sixth instruction call, multiplying each exponential by the denominator to produce results.

The method further includes commanding, with a seventh, fused mixed precision floating point instruction call, scaling of the results; and commanding, with an eighth fused mixed precision floating point instruction call, further scaling of the scaled results by an inputted common scale factor.

The method further includes flushing output subnormals to 0.

A further aspect provides an instruction set architecture (ISA) supported by instruction decoding circuitry capable of decoding: a first mixed precision fused addition/subtraction and fixed floating point precision conversion instruction, a second mixed precision fused multiply and fixed floating point precision conversion instruction, a third mixed precision half-precision fused multiply-add and fixed floating point precision conversion instruction, a fourth mixed precision single precision fused multiply-add instruction providing single to half fixed floating point precision conversion, a fifth mixed precision fused half-precision floating-point multiplication and fixed floating point precision conversion instruction, and a sixth mixed precision fused scaling and fixed floating point precision conversion instruction.

A further aspect provides a non-transitory memory device storing code that when executed performs computations, the stored code comprising: a first mixed precision fused addition/subtraction and fixed floating point precision conversion instruction, a second mixed precision fused multiply and fixed floating point precision conversion instruction, a third mixed precision half-precision fused multiply-add and fixed floating point precision conversion instruction, a fourth mixed precision fused multiply-add instruction providing single to half fixed floating point precision conversion, a fifth mixed precision fused half-precision floating-point multiplication and fixed floating point precision conversion instruction, and a sixth mixed precision fused scaling and fixed floating point precision conversion instruction.

Use of Fused Mixed precision floating point Instructions Increases Instruction Throughput & Makes SoftMax Faster and More Efficient

A particular advantageous use case for the present technology is to implement a “mixed precision floating point” SoftMax or Flash Attention providing a combination of different precision calculations, for example within the context of a hardware compute pipeline of streaming multiprocessors or other processing cores of a GPU. Such a “mixed precision floating point” SoftMax or Flash Attention may efficiently perform some computations in higher precision and other computations in lower precision without incurring performance penalties for changing precisions.

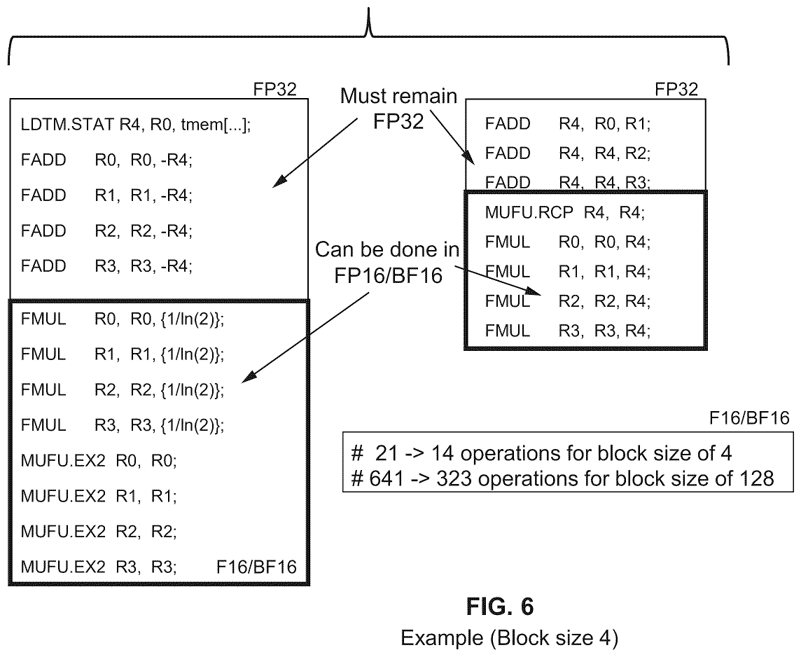

As FIG. 6 graphically indicates, because SoftMax is sensitive to quantization errors as noted above, some SoftMax calculations such as computing SoftMax deltas in the input block (FADD instructions) should be performed in higher precision such as fp32. The SoftMax calculation applies an exponential operation (FMUL, MUFU instructions) to deltas calculated by the FADD instructions. Such exponential operations could magnify even small rounding, truncation or range errors, which can lead to instability due to overflow/underflow and/or cause a NN model to misclassify. On the other hand, once SoftMax delta values have been calculated in higher precision, the results can be converted so subsequent operations are then performed by faster, lower precision computations in contexts where small rounding or truncation errors have little or no meaningful or significant impact. fp16 has fewer bits than fp32. We can sacrifice a little bit of accuracy for a large improvement in register file (RF) bandwidth and execution resources. In example embodiments, certain operations now take fp32 inputs, but produce fp16 outputs.

A goal in example embodiments is to take advantage of opportunities to use SIMD 16 bit operations. SoftMax tends to fit in fp16 range. We focus on fp16 since it has more fraction bits (higher accuracy) but we keep a Brain Floating Point (bf16) option open for the portions that don't fit in fp16 (e.g., accumulating larger block sizes, and small gradients in the backwards pass).

We accelerate transitions between 32 bit and 16 bit phases by not spending one instruction converting/packing to save one instruction.

We accelerate quantization of subsequent MMA inputs by scaling 16 bit elements (general), and optimizing MX scaling (FP8/FP6).

Example embodiments herein strategically switch processing from higher precision to lower precision and from lower precision to higher precision to achieve higher speed/efficiency while reducing likelihood that rounding, truncation or range errors resulting from lower precision calculations will cause problems. A rough analogy is spending more on furnishings and decorations for your living room and dining room while furnishing more frugally those upstairs and attic rooms that are rarely visited or seen by guests. The ability to protectively conceal the effects of faster, lower precision processing steps by wrapping them with higher precision processing steps strategically selectively used where higher precision counts (e.g., to avoid SoftMax quantization errors), offers throughput and accuracy advantages.

Meanwhile, example embodiments provide a unique ability to go back and forth between higher precision processing and lower precision processing without incurring the penalty of additional instruction overhead—avoiding the typical overhead penalties usually incurred when temporarily switching to and from lower precision to temporarily speed up processing. In example embodiments, such switching is accomplished by providing fused mixed precision floating point instructions that perform needed operations (e.g., summation) that are fused within “built in” precision conversion capabilities (see FIG. 5B).

The built in (e.g., programmable) precision conversion capabilities of fused mixed precision floating point operations essentially come along for the ride—meaning the capabilities do not significantly increase processing time when invoked. Each invocation of a mixed precision floating point instruction fusing a typical calculation operation such as multiply or summation with a precision conversion operation, offers the benefit of a “bonus” precision conversion that can be exploited to decrease instruction count, decrease processing time, and reduce register accesses.

Basically, with the present approach, there is no performance penalty for bridging from the higher precision domain in the FIG. 6 example to a lower precision domain or vice versa. The number of instructions that need to be executed is therefore decreased (fewer instructions are pulled from the instruction cache), and travel time back to the register file (total register access time) is also reduced correspondingly. Furthermore, it is sometimes simpler for the calculation hardware to reduce precision (e.g., by dropping output bits and/or rounding) in data that a calculation circuit is already presenting on a data path and thus is already available for further processing.

In one example embodiment, the strategic use of fused mixed precision floating point instructions offers almost or substantially the same performance as if all calculations were performed in fp16 but with the almost or substantially the same accuracy as if the operations were all being performed in fp32. Moreover, the number of instructions in the fused mixed precision floating point approach is significantly less than the number of instructions for the traditional approach of using separate conversion instructions (in one example use case, 21 operations for the prior approach versus 14 operations for the new fused mixed precision floating point approach for a SoftMax block size of 4, this difference increasing to 641 versus 323 operations for a block size of 128).

Thus, example embodiments implement “mixed precision floating point” SoftMax using fused “mixed precision floating point” instructions that perform a desired operation such as floating point multiplication or floating point addition, while also converting from one precision and/or format to another precision and/or format. In one example embodiment, the calculating itself could be performed in a single precision and/or format—usually the wider precision and/or format if the calculation receives one precision as input and outputs a different precision. However, embodiments use mixed precision floating point instructions to narrow precision in the course of (as part of) performing a commanded operation, or to widen precision in the course of (as part of) performing a commanded operation.

In some embodiments, each fused mixed precision floating point instruction format can be programmable, i.e., parameters in the instruction call specify to hardware whether and how to perform any conversion from one precision to another precision, such as by selecting between different floating point output precisions and associated formats. Thus, some calls to a given instruction result in an operation plus a precision conversion, whereas other calls to the same instruction result in that operation plus a different precision conversion or no precision conversion. In some example embodiments, execution time of these different calls of the instruction are the same, meaning there is no performance penalty for invoking the conversion option.

Because of Flash Attention's reliance on SoftMax, improved SoftMax operations have the potential to realize further improvements in throughput and register file bandwidth anywhere Flash Attention is used. In many architectures in contrast, SoftMax and quantization are limited by instruction throughput rates in executing those operations, and by the bandwidth of the Register File (RF) for accessing data in performing those operations. Both RF bandwidth and instruction issue rates are also important resources for other work that's happening in parallel.

Hence, example non-limiting technology herein provides an improved machine microarchitecture and associated application programming interface (API) for a new ISA, supported by improved hardware calculation circuits, for more efficiently performing SoftMax and/or quantization (or Softer Max, Flash Attention and other probability distribution calculations or other calculations) e.g., between MMA stages, without the significant performance penalties that commonly result from reduced precision.

### Example New Fused Instructions

The following illustrative example mixed precision instruction formats are provided in a new instruction set architecture (ISA) that provides instructions/operations that perform at least one calculation (e.g., subtraction, scaling, etc.) and convert from one precision and/or format to a different precision and/or format. Each of these mixed precision instruction formats is assigned a corresponding distinctive single “operation code” (opcode) configured to be called in a single (micro) instruction call representing a single self-contained atomic action, with no internal steps that depend on or require separate additional commands or instruction calls. Each instruction represents exactly one unitary overall operation and is fulfilled with exactly one atomic action (which may have multiple stages) performed by the hardware.

In addition to the opcode, the instruction format may include (a) one or more operands, and (b) one or more memory and/or register addresses and (c) one or more mode specifiers (i.e., the instruction may have multiple programmable modes). All of this information for a given instruction is specified in a single binary instruction format as part of a single discrete application programming interface (API) call, configured to be stored in a cache memory at a single address for loading together into a single instruction register (IR) of an instruction decoder circuit within the hardware.

The instruction decoder circuit decodes the opcode and mode bits and generates signals to control an arithmetic logic unit (ALU) to perform the operation(s) and mode(s) the instruction specifies. The operands may be “immediate” operands contained in the instruction format itself, or “indirect” operands that specify “source” storage locations such as registers or memory locations where the operands are stored. The instruction format further specifies a “destination” storage location where a result(s) of the operation is to be stored upon completion of the execution of the instruction. The hardware may perform a sequence of sub-operations or stages the instruction specifies. The sub-operation(s) or stages performed by the instructions specified below can include for example:
accessing (loading) an operand(s) from a register(s),
performing a computation such as one or more mathematical calculations on the operand(s) to produce a result(s) at a first precision,
converting the result(s) from the first precision to a second precision different from the first precision, and
writing the result(s) at the second precision to a destination register(s) or other storage location(s) either alone or “packed” with another result(s) such as another precision-converted result(s)(in one embodiment, the hardware can perform plural or multiple instructions in parallel to generate plural or multiple results in parallel).

### Example Fused Instruction “FHADD2” (Fused Addition/Subtraction)

Example Format: FHADD2.F16x2.F32x2.F32x2.RZ.FTZ [register specification]

FHADD2 could instead be implemented by the following multiple legacy instructions:
FADD2.RZ Rtmp, {−}Ra{.swz}, {-}Rc{.swz}
F2F.F16.F32.RZ.FTZ Rtmp, Rtmp
F2F.F16.F32.RZ.FTZ Rtmp+1, Rtmp+1
PRMT Rd, Rtmp+1, 0x5410, Rtmp;

Each FHADD2 instruction thus combines addition, convert to fp16, and pack all in one step, and avoids F2FP, PRMT packing needed for following instructions such as HMUL2, MUFU. FHADD2 thus avoids the need for executing separate, explicit type conversion and packing instructions in computing sum/differences and storing two 16-bit values together in a 32-bit register.

Thus, n→4n/2→n/2 instructions (i.e., the number of instructions needed in some contexts are halved by using this new instruction).

In the example format above, .RZ rounding and fp16.FTZ are acceptable in one embodiment. Other implementations could support other or additional rounding modes at increased hardware cost (for example, RZ rounding can be performed in hardware with right shifters). Conversion from fp32 to fp16 denormal may also benefit from extra right shifters; but example embodiments flush denormals to zero to avoid adding new hardware. Other implementations could make different tradeoffs.

bf16x2 output is also provided in example embodiments.

In example embodiments, subtraction is in fp32 to handle values that are close to the local maximum (they differ only in LSBs, but still have a large magnitude; the difference can fit in fp16). The output in example SoftMax embodiments below is passed to MUFU.EX2, so .FTZ is fine. RN would be better than .RZ, but difference is small, and the amount of additional hardware might be large. Other implementations could make other different design vs. functionality tradeoffs.

While throughput of FHADD2 isn't any better than two legacy FADDs/FHADDs, FHADD2 lets us use ALU/MUFU in parallel (effectively improving issue rate), and packs output so later passes can use higher throughput instructions.

Another example implementation variation of this mixed precision instruction: FHADD2.F32x2.F16x2.F32x2 {.rnd} is equivalent to:
FHADD.mode16{.rnd}Rd+0, Ra_fp16{.swz}, Sc_fp32{.swz};
FHADD.mode16{.rnd}Rd+1, Ra_fp16{.swz}, Sc_fp32{.swz};

This variant is just like the legacy FADD2 instruction, but with a fp16 (or bf16) input used to accelerate exponential sum (exponentials are in fp16/bf16, accumulator to be fp32 (x2). This instruction can be used for example to reduce a SoftMax denominator optimized from n to n/2 instructions.

### Example Instruction “FHMUL2” (Fused Multiply)

A mixed-precision multiplication (vectors of fp32*fp32→fp16) instruction can be used e.g., to accelerate quantization. In one embodiment, this “FHMUL2” instruction takes two fp32 input values and produces a product in fp16 or bf16 or fp8 or fp6 or fp4 format.

Functionality: FHMUL2 with Separate A & B Formats

### Example Format

FHMUL2.adFmt.bFmt Rd, Ra{.iswzA}, Rb{.iswzB}
(Destination format is the same as the A format)

This instruction may be used for output scaling with larger block sizes (as block sizes get larger, e.g. with fp4, 1.0/exp_sum in fp16 may not have enough range to avoid underflow).

### Example Instruction “FHFMA2” (Half-Precision Fused Multiply-Add)

A mixed precision floating point instruction FHFMA2 performs A*B+C to produce D (where A and C are fp32 values, B is a fp16/bf16 value, and D is a fp32 value).

### Example Format

FHFMA2.F32x2.F16x2.F32×2.F32×2
Operation: multiply fp16/bf16 by an fp32, result is fp32.

In example embodiments, FHFMA only does 16-bit by 16-bit float multiply. This avoids the need for the F2FP operation, and thus extra RF bandwidth for fp32 scale factor. It may be used for Flash Attention block scaling, when stored in fp32.

Variant: Example Instruction “FHFMA2” (Fused Multiply-Add) Providing Single to Half (fp32→fp16) Precision Conversion

A variant of the above-described “FHFMA2” instruction (which computes two fused multiply-adds) has the inputs are in fp32 format, and the output is in fp16 format, in a manner similar to the FADD2 instruction described above. As explained above, the use of this new fp32→fp16 FHFMA2 variant introduces significant numerical instability. However, it seems that for some DL models, this numerical instability doesn't show, or isn't important enough to affect the classification. This variant instruction is thus a bit different from the other new instructions described herein which e.g., can be used to accelerate the numerically stable version of SoftMax.

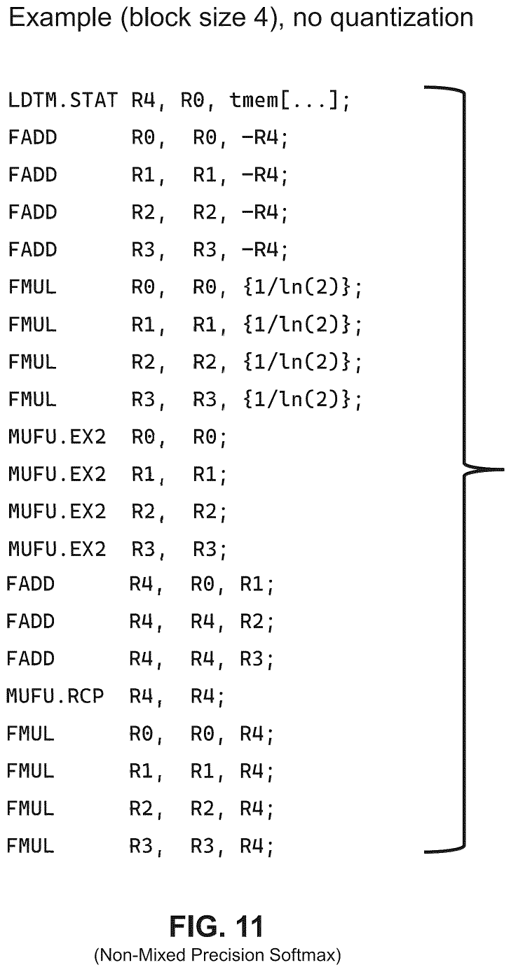

Recall the discussion above in connection with FIG. 11 where we said that

$$( x\_i - max ) * ( 1 / ln ( 2 ) )$$

is mathematically, the same as:

$$( x\_i * 1 / ln ( 2 ) ) - ( max * 1 / ln ( 2 ) )$$

Since there is only 1 max value, we can compute the last part of the equation just once, and then treat it like some constant “C” for each element:

$$( x\_i * 1 / ln ( 2 ) ) - C$$

The above can be implemented using a single legacy FMA instruction. Combining it with other technology herein, we need x_i and C to both be in fp32 format. 1/ln (2) could be in any format, but in one embodiment we choose to keep it as fp32. The result is down-converted to fp16 just like the FADD operation described above. The rest of the computation is in fp16.

Note: we said “mathematically, the same as” a few lines above, but it turns out that property doesn't work in practice in the world of fixed-precision floating-point (i.e., floating point with a fixed number of significand digits/mantissa length). Specifically:

$$( x\_i - max ) * ( 1 / ln ( 2 ) ) != ( x\_i * 1 / ln ( 2 ) ) - ( max * 1 / ln ( 2 ) )$$

because in floating-point:

$$A * C + ( B * C ) != ( A + B ) * C .$$

Specifically, floating-point operations are not strictly associative or distributive due to rounding errors—a consequence of how digital processors represent fractional numbers. For example, each floating point addition or multiplication can introduce a rounding error. Furthermore, changing the order of the operations can affect the result (e.g., the intermediate result of A*C might be rounded before the addition, whereas (A+B)*C might produce a different intermediate sum, and thus a different rounded final result. The intermediate steps (products vs. sums) can thus exhibit different rounding behaviors, leading to different final values.

The problem here: C=max*ln(2) is computed and then rounded to the target format (say fp32). No matter which rounding mode is used, there can be a loss of some of the precision of the answer. Later, when we compute (x_i*1/ln (2))−C, the x_i*1/ln (2) part is computed with infinite internal precision, then the subtraction of C happens, and that result is rounded to the target format. So it's entirely possible that for x_i==max, x_i*1/ln (2)−C is not zero (whereas outside of this additional instruction variant implementation which includes rounding to a target format, that result is exactly 0).

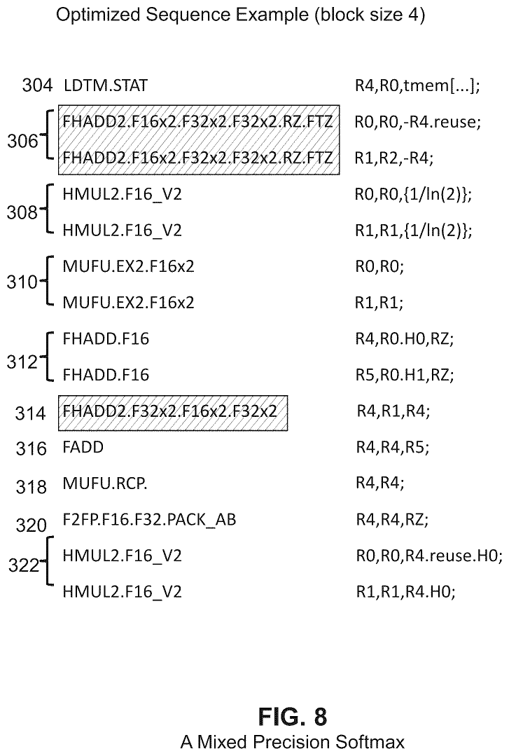

Because the result is non-zero in this context and in fact can be a positive number, things can break down numerically: We expect that the input to the 2^{x} function (the MUFU operation shown in FIG. 8) is some number ≤0, the largest output of the operation is 1.0 (because 2⁰==1). But here, the largest input to the MUFU operation can be some arbitrarily large positive number, so the output of 2^{x} can become very large, and in fact can become infinity in some cases. The numerics all break down from there.

So this “FHFMA2” fused instruction variant should preferably be used when the model has been properly conditioned to avoid this situation where the numerics can break down completely, and in cases where the largest output isn't 1.0, but some other number (like 2, or 15) is acceptable.

In contexts where the new instruction variant can be used, the new instruction variant reduces cost of SoftMax and quantization from 3n instructions to 2.5n instructions.

### Example Instruction “HMUL2” (Fused Half-Precision (FP16) Floating-Point Multiplication)

A mixed precision floating point instruction HMUL2 may be used for output scaling with larger block sizes, i.e., to perform E*F to produce G (where E is a bf16 value, F is a fp16 value, and G is either a bf16 or fp16 value). The different float formats utilized in the FHFMA2 and HMUL2 instructions accommodate the different block formats used. These instructions avoid separate, explicit conversion instructions, and reduce the required RF bandwidth that would have been required in performing explicit conversions.

Example HMUL2 is with Separate A & B Output Formats:
HMUL2.adFmt.bFmt Rd, Ra{.iswzA}, Rb{.iswzB}
(In example embodiments, the destination format is the same as the A format.)

### Example Mixed Precision Instruction “F2FP” (Fused Scaling)

As a tag to the end of SoftMax(see below) before another large matrix multiplication, it is often desirable to convert from whatever format is being used (fp32, FP64, etc.) to a format more suited for the subsequent matrix multiplication—which might use vastly reduced precision in a much narrower format such as 4, 6 or 8 bits wide (MX scaling). To do such a conversion involves scaling the operands by factoring out a common scaling factor from a set of operands, and then dividing out that scaling factor from every operand. A software program running on a processor communicating with the SM may typically determine this common scale factor across many values, and provide the scale factor as an input (e.g., in E8 format) to a hardware computation block that does this scaling.

For folding scaling in the format conversion operation, a new fused mixed precision floating point instruction F2FP may be used to accelerate block quantization to MX fp4/fp6/fp8, to provide a SCALE_BY_C operation mode. In that mode, F2FP accepts two input values (in fp32, fp16 or bf16 format) and an input scale factor and first converts the two input values into a smaller format (e.g., 4-bit floating point (FP4) format) while also performing a division by the input scale factor. This reduces the number of instructions and their corresponding register reads to do the type conversion and scaling.
F2FP with MX fp4/fp6/fp8 Scaling
F2FP{.SATFINITE}{.RELU}.dstfmt.F32.PACK_AB_MERGE_C.SCALE_BY_C.rnd
F2FP{.SATFINITE}{.RELU}.dstfmt.F16/bf16.UNPACK_B_MERGE_C.SCALE_BY_C.rnd
F2FP{.SATFINITE}{.RELU}.dstfmt.bf16.UNPACK_B_MERGE_C.SCALE_BY_C.rnd

Shortcut: Scaling flushes input subnormals (denormals; a set of values that are very small and have special ways of being represented) to 0 (in order to simplify the hardware implementation)

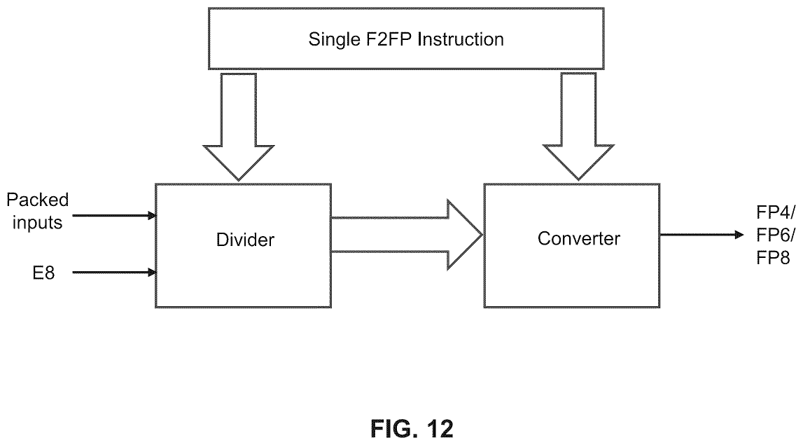

FIG. 12 is an illustrative block diagram of hardware computation blocks to support the new mixed precision F2FP instruction.

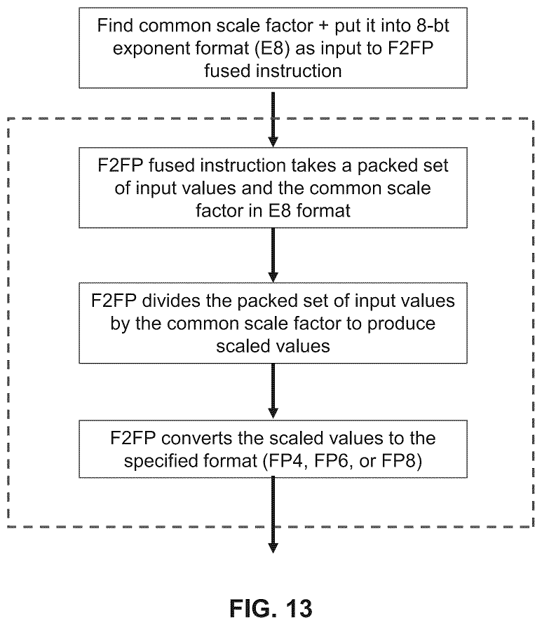

As illustrated in FIG. 13, example embodiments of this F2FP with MX instruction divides out the scaling factor and does conversion to a (programmable) lower precision. The instruction fuses into a single instruction the division by the scaling factor, e.g., with conversion to the narrower format(s). Not every floating point value at the output of the conversion necessarily has the same exponent—they might have different exponents but a common scaling factor. This new instruction potentially provides a two-to-one speedup compared to a conventional F2FP-based implementation that uses separate multiplication and conversion instructions.

As FIG. 13 illustrates, the instruction functionality itself (shown in dotted box) in example embodiments does not calculate the scale factor, but instead accepts the scale factor as an input. For example, an external or other computation process may find a common scale factor C and put it into 8-bit exponent format (E8) as input to the new instruction. The new instruction also receives a packed set of input values, divides the packed set of input values by the (common) scale factor to produce scaled values, and converts the computed scaled values to a specified format, e.g., FP4, FP6, or FP8 compliant with the MX specification.

The F2FP instruction can advantageously be used with SoftMax, but also has general utility independent of SoftMax—for example, any time division by a scaling factor is followed by conversion to a lower precision such as for matrix multiplication, HDR graphics, graphics blending, etc.

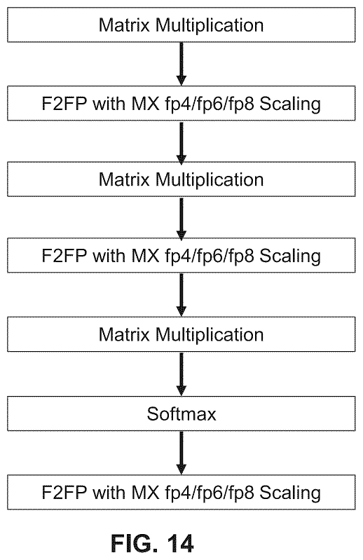

As a further example, within large AI models, there are typically many stages of matrix multiplication. Some of those stages may have a SoftMax before it, but other stages may not have a SoftMax before it. As illustrated in FIG. 14, this F2FP with MX instruction can be used in every or any stage before each or any successive matrix multiplication—not just in the stage with SoftMax. One example use is converting results to an MX scaling format.

### Example Use Case: SoftMax Implementation

A new approach for performing SoftMax and quantization is provided that uses such fused mixed-precision floating-point operations so certain parts of certain operations can be performed with fewer operations/instructions and/or fewer bits and/or fewer RF accesses. This specifically optimizes the fp32 SoftMax/Flash Attention algorithms. We also mildly accelerate fp16 SoftMax/Flash Attention by speeding up the quantization step.

In this context, by “mixed precision floating point” we mean to include the format of the data as well as its numerical range. For example, IEEE fp16 (floating point 16) and bfloat16 (Brain Floating Point 16) technically have the same numerical precision (16 bit floating point) but different formats. IEEE fp32 (floating point 32) meanwhile has both a different numerical precision (32-bit floating point) and a different format as compared to fp16 representations. See IEEE table at the end of this specification. Conversion can be numerical precision conversion, format conversion, or both numerical precision and format conversion.

The resulting SoftMax implementation is a combination of legacy instructions documented in the above-referenced cuda-binary-utilities Release 13.1 and newly-developed mixed precision instructions described herein.

### Summary of Mixed Precision Floating Point Operation For SoftMax:

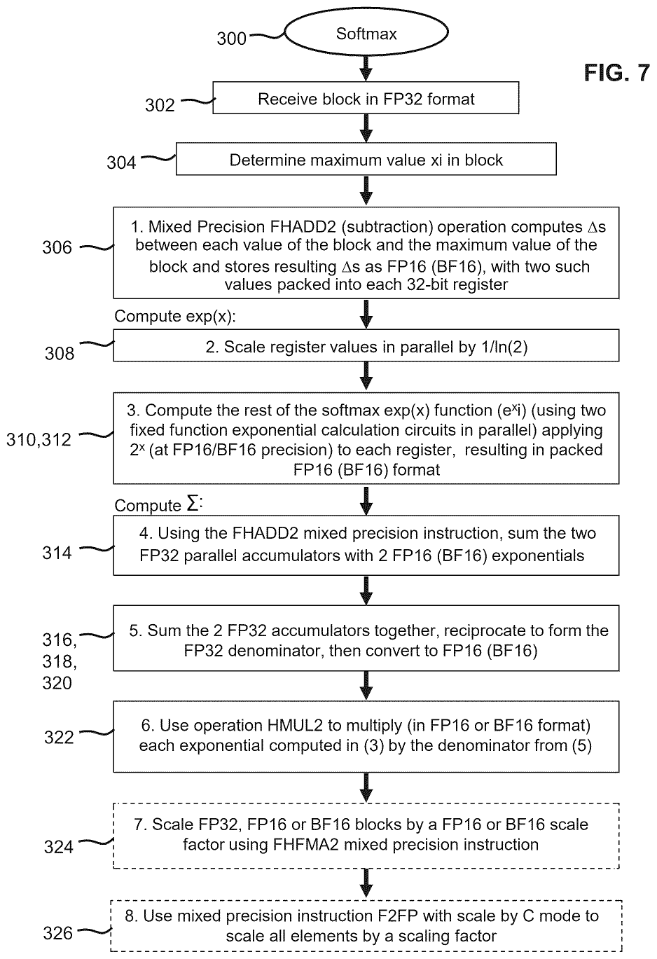

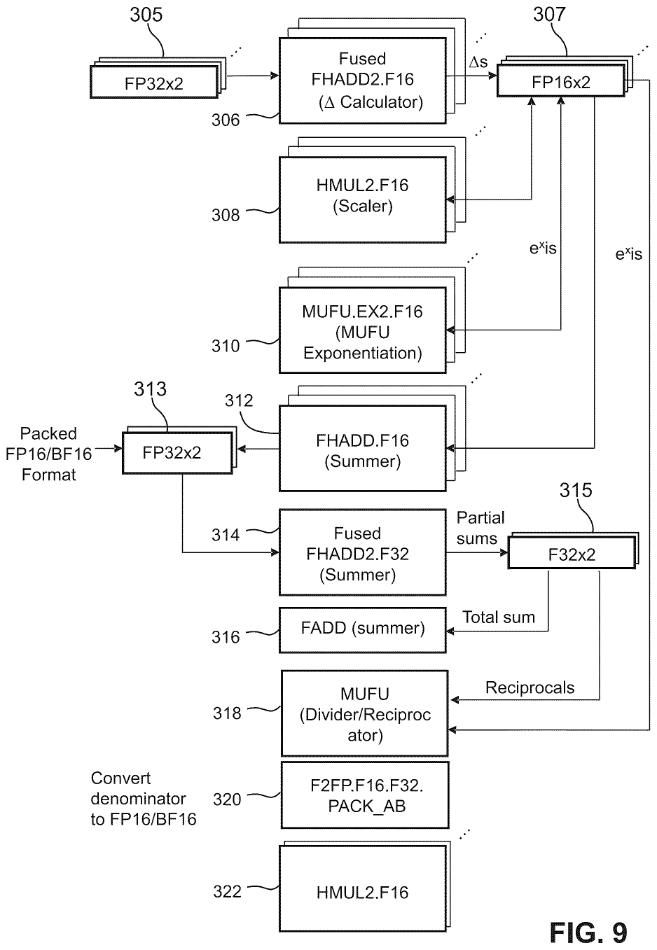

FIG. 7 shows an example flowchart of an example embodiment of an improved mixed precision SoftMax, FIG. 8 shows example corresponding pseudo-code, and FIG. 9 shows a corresponding pipelined hardware computation invocation (in this example, registers 305, 307, 313, 315 are shown individually but may be part of a conventional register file).

This non-limiting illustrative example SoftMax use case receives a vector of raw scores (logits); exponentiates each element (using ex) to make them positive and amplify differences; sums all these exponentiated values to get a normalization constant; and divides each exponentiated value by this sum to produce a probability distribution where all outputs are between 0 and 1 and sum to 1.
1) FIG. 7 block 302, 304, 306: Compute the delta between each value of a fp32 input data block and the maximum value xi of the data block (each in fp32 format), and store the resulting difference as fp16 or bf16 (see e.g., FIG. 9, registers 307). We avoid an explicit conversion & packing operation by providing a fused instruction (FHADD2). To simplify the implementation and reduce the area cost, we flush output subnormals to 0 when the output is in fp16 format. This allows us to build this feature with no additional hardware. Example FIG. 8 has a block size of 4, so two FHADD2 instructions (306) are called (one for each pair of fp32 inputs). Correspondingly more FHADD2 instructions are employed for larger block sizes.
2) Block 308: We begin computing exp (x) by first scaling the register 307 values by 1/ln (2). Since the operation in 1) provides two fp16/bf16 values in a packed format (FIG. 9 block 307), we can use a single instruction to perform the scaling on 2 inputs in parallel, saving both instruction issue and RF bandwidth. Example embodiments don't introduce new features to directly accelerate this step, but instead enable that step to be efficiently performed using existing fp16 operations (i.e., HMUL2). See Parallel Thread Execution ISA Version 9.0 (NVIDIA 2025); docs.nvidia.com/cuda/parallel-thread-execution/. Alternatively, example implementations in other embodiments could add a further new fused instruction (FHMUL2.F16x2.F32x2.F32x2.RZ.FTZ) for block scaling acceleration.
3) Blocks 310 (312): We then compute the rest of the exp (x) function using two to the power of x function at fp16/bf16 precision. We double the speed of that computation by performing it on the aforementioned packed registers, and providing twice the exponential computation hardware (MUFU.EX2 instruction). Precision is not too important here, so having the inputs (FIG. 9 block 307) and results (FIG. 9 block 313) in a packed fp16 (or bf16) format is acceptable. Processing packed fp16/bf16 values saves us half the RF bandwidth for this operation.

In example embodiments, the speed in performing these computations is thus doubled by performing the scaling above on packed registers using MUFU.EX2, utilizing two fixed-function units in hardware (each referred to herein as MUFU) for performing exponential computations in parallel. In one embodiment, these exponential calculations are performed by multi-function units (MUFU) hardware 114. The exponential values e^{xi} are thus computed by the scaling 308 followed by “to the power of x” functions. Having the inputs and results in a packed fp16 (or bf16) format provides adequate precision. Processing this operation using packed fp16 (bf16) values reduces accesses to the RF by half.

4) Blocks 312, 314: Summing all those fp16 (or bf16) exponentials employs an fp32 accumulator (block 315) to not lose important information. We provide a fused fp32 FHADD2 instruction variant that sums two parallel accumulators with 2 fp16 (or bf16) exponentials. In example embodiments, the summing is thus done is two stages, and FHADD2 is designed to be able to sum two parallel accumulators with two fp16 (or bf16) exponentials. We reduce the RF bandwidth required by the accumulation from two 32-bit register reads down to 1.5 32-bit register reads per element. In the FIG. 8 example shown, while there are only two “FHADD” instructions in this block size=4 example, there would be a longer sequence of “FHADD” instructions for larger block sizes (e.g., 128 blocks). Other implementations could sum the exponentials directly into a single accumulators, or into 4 accumulators, etc.

By way of further explanation as to precision, there is a need to be careful here since exponentials can magnify least significant bit (LSB) differences and thus cause quantization errors that can cause trouble with SoftMax. Based on an accuracy study, example embodiments limit error by keeping maximum value & difference computations as fp32. The accumulator needs ~24 mantissa bits so the example embodiment keeps the accumulator(s) as fp32. However, the rest of the computation can be done as fp16 to improve speed performance. Result: RMS error of 1/1700 for block size of 128, fp16 vs fp32.
5) Blocks 316, 318, 320: We then sum (FADD) the fp32 accumulators together and then reciprocate it (the sum)(MUFU) to form the fp32 denominator, then convert that fp32 denominator to fp16 or bf16 (F2FP.F16.F32.PACK_AB). This step is not further accelerated by any new fused instructions in this particular example, but could be.

In the FIG. 8 example, MUFU (318) computes fp32 functions with fp32 results, and fp16 functions with fp16 results, etc. So when reciprocating the fp32 denominator, we use a separate step F2FP.F16.F32 (320) to do the conversion to fp16 (in the FIG. 8 example, that takes the form of an F2FP instruction).

In another embodiment, MUFU instruction 318 could instead be a mixed precision instruction such as:
MUFU.RCP.F16.F32.RZ R4, R4;
providing an inline conversion from fp32 to fp16. In that scenario, no additional F2FP operation would be needed to perform the conversion.
6) Block 322: We multiply each exponential we had computed in 3) by the denominator from 5). The denominator was already converted to fp16/bf16 format per the previous step 314, and the exponentials are in fp16/bf16 per step 310. Thus, everything is in fp16/bf16 at this point. This operations thus can use a pre-existing legacy operation (HMUL2). Like 2) above, this example does not use any new instructions of example embodiments to directly accelerate this step, but enables legacy half-precision operations to be used, reducing the RF bandwidth requirement from 2 registers/element down to an average of 1 register/element.

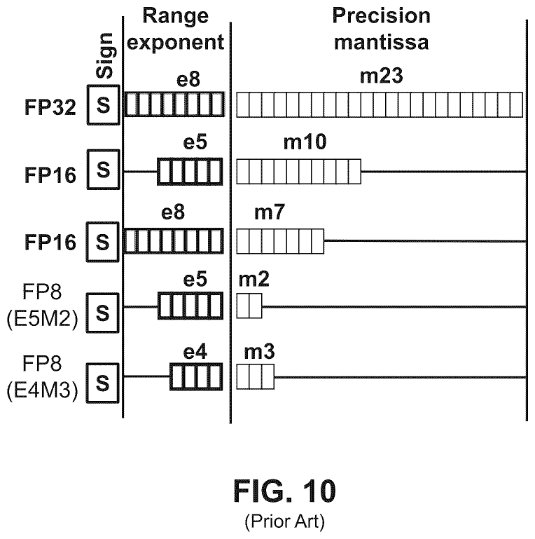

As shown in FIG. 9, blocks 320, 322 are thus part of “vanilla” SoftMax. For Flash Attention, these operations would be folded into the correct step (see below).
7) Block 324: For Flash Attention, we also need to scale fp32, fp16 or bf16 blocks by a fp16 or bf16 scale factor (computed by a variation of #5 above). We provide mixed precision FHFMA2 (fp32*(fp16/bf16)+fp32-→fp32) and HMUL2 instructions (bf16*fp16-→fp16 or bf16). The different float formats accommodate the different block formats used. These operations avoid explicit conversion instructions, and reduce the required RF bandwidth that would have been required.
8) Block 326: Finally, the quantization step requires scaling all elements of a vector by some common scale factor (typically, some factor of the largest element in the vector). This step would normally require additional HMUL2 instructions for fp16 or bf16 scaling. However, when the scale factor is in exponential-only format (e.g. the E8 format-see FIG. 10), we can fold the scale in the format conversion operation. We've augmented the F2FP instruction to add a. SCALE_BY_C operation mode. In that mode, we perform two conversions from fp32, from fp16 or from bf16 into smaller formats (e.g. fp4) as normal, but also perform a division by the supplied scale factor. This saves us issuing the HMUL2/FMUL instructions and their corresponding register reads.

For fp16/bf16 SoftMax, only step 8) is accelerated by example embodiments.

All in all, we reduce instruction count from an average of 6.5 instructions down to 3 instructions per element (amortized). We also reduce register file reads from 8 registers/element down to 5 registers/element.

In another embodiment, in certain constrained cases as described above, using a mixed precision fp32→fp16 variant of FHFMA2 for multiply-adds to compute in SoftMax the difference between each element and the max element, and then scale by 1/ln (2) to compute the exponential, that is compute

$$( x\_i * 1 / ln ( 2 ) ) - C ,$$

can further reduce the instruction count down to 2.5 instructions per element (amortized).

The new approach has been presented with respect to fp32 SoftMax and Flash Attention algorithm use cases but the general concepts can be applied to other precision SoftMax operations (e.g., 64-bit floating point (FP64), 16-bit floating point (fp16), and the like), other DL algorithms, or any other algorithms that make use of SoftMax or quantization or provide probability distribution outputs. The mixed precision floating point instructions and associated hardware implementations discussed herein are thus not strictly limited to SoftMax or quantization, and may be used and useful in other contexts.

### Example Use Case System Block Diagram

FIG. 15 depicts an exemplary hardware processing element 800 that may benefit from implementing one or more of processing elements described herein. The processing element 800 includes a plurality of vector multiply-accumulate units 802 along with fused mixed precision floating point and other calculations, a weight buffer 812, an activation buffer 804, a router 806, a controller 808, an accumulation memory buffer 810, and a post-processor 814. The activation buffer 804 may, in one embodiment, be implemented as a dual ported SRAM to receive activation values from a global buffer or from other local or global processing elements, via the router 806 or other interconnect. The router 806 may be a component of a distributed network-on-a-chip router that in one embodiment comprises a serializer/de-serializer, packetizer, arbitrator, Advanced extensible Interface, and other components known in the art. All of the blocks and circuits shown in FIG. 15 are in one embodiment disposed on the wafer(s) of an integrated circuit package(s) such as a system-on-chip (SOC) including a GPU and a CPU.

The weight buffer 812 may, in one embodiment, be implemented as a single-ported SRAM storing weigh values. The weight values used by the vector multiply-accumulate units 802 may be “weight-stationary”, meaning they are not updated each clock cycle, but instead are updated only after the output activation values are computed for a particular layer of a deep neural network.

The accumulation memory buffer 810 may comprise one or more SRAM devices to store the output activations computed by the vector multiply-accumulate units 802. The router 806 communicates these output activations and control signals from the processing element 800 to other processing elements. “Output activation” refers to an activation output by a neuron in a neural network. An output activation is typically computed based on the input activations to the neuron and the weights applied to the input activations. “Input activation” refers to an activation received by a neuron in a neural network.

The processing element 800 may perform all operations of convolutional and fully connected layers of a DNN efficiently, including multiply-accumulate, truncation, scaling, bias addition, ReLU, and pooling. The vector multiply accumulate units 802 may operate on the same inputs using different filters. In one embodiment, each of the vector multiply-accumulate units 802 performs an n-input-channel dot product and accumulates the result into the accumulation memory buffer 810 on each clock cycle. The weights stored in the weight buffer 812 are unchanged until the entire computation of output activations completes. Each processing element 800 reads the input activations in the activation buffer 804, performs the multiply-accumulate operations, and writes output activations to the accumulation memory buffer 810 on every clock cycle. The frequency at which the weight buffer 812 is accessed depends on the input activation matrix dimensions and the number of filters utilized.

The vector multiply-accumulate units 802 of each processing element 800 computes a portion of a wide dot-product-accumulate as a partial result and forwards the partial result to neighboring processing elements. “Dot-product-accumulate” refers to the computation of a dot product. A dot product is the sum of the products of the corresponding entries of the two sequences (vectors) of numbers. Dot products are efficiently computed using vector multiply-accumulate units. “Multiplier-accumulator” refers to a data processing circuit that carries out multiply-accumulate operations, which involve computing the product of two numbers and adding that product to an accumulator. Multiplier-accumulators may be referred to herein by their acronym, MAC or MAC unit. As discussed above, the multiplier-accumulator carries out computations of the form a ←a+(b*c). The vector multiplier-accumulator computes the product of two vectors using an array of multipliers, then performs a reduction operation by adding all the outputs of multipliers to produce a partial sum, which is then added to an accumulator, as described above, using the fused mixed precision floating point instructions described herein. The vector multiplier-accumulator 802 may thus implement a repertoire of example calculation functions described in CUDA Binary Utilities v13.1 (Jan. 8, 2026) along with the additional/new mixed precision instructions described herein.

The partial results are transformed into a final result by the post-processor 814 and communicated to a global buffer that acts as a staging area for the final multiply-accumulate results between layers of the deep neural network. In this example, the post-processor 814 can perform SoftMax or Flash Attention, and can implement these using the FIG. 4 streaming multiprocessors in a parallel fashion (i.e., hundreds of streaming multiprocessors can operate concurrently on the same large matrix).

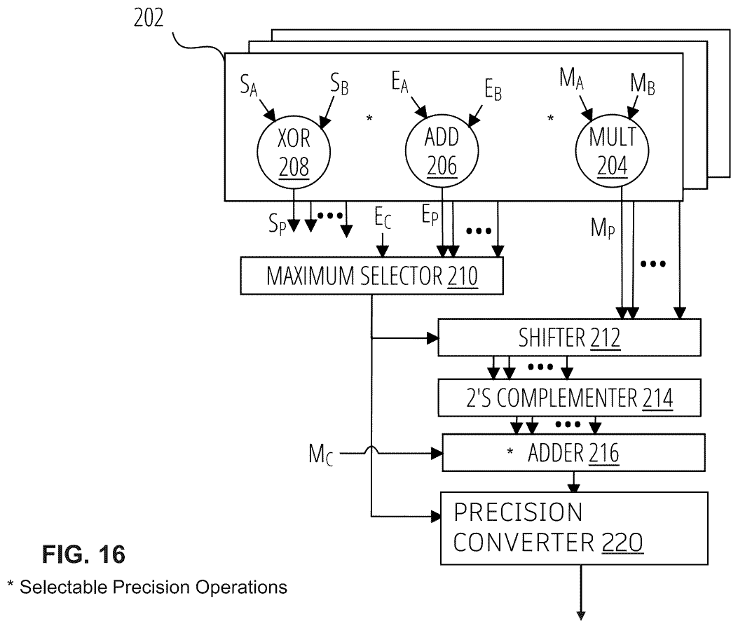

FIG. 16 depicts an example micro-architecture 202 of an example data path within the vector MAC units 802 of FIG. 15 (and which may also be used within the FIG. 4 SM circuit fp32 items 110). The example data path comprises four stages.

Stage 1, comprising a mantissa multiplier 204, adder 206, and XOR logic 208 in each multiply-accumulate unit, computes a product of the vectors by multiplying the mantissa, adding the exponents, and XORing the sign bits, respectively, of two operands A and B.

The product exponents from each multiply-accumulate unit are applied to a maximum selector 210 to select the maximum value thereof. The maximum selector 210 and shifter 212 utilize the exponent sums output by the adders 206 to perform a data alignment function on the mantissa products output from the mantissa multipliers 204, so that the mantissa products may be reduced by the adder 216 and converted appropriately.

The product exponent values are aligned for addition by shifting the product mantissas with a bitwise shifter 212. These values can be processed through a 2's complementor 214 and an adder 216 to perform vector addition and accumulation of the resulting values, along with the mantissa of a third operand C.

The accumulated result is converted by a converter 220 into a desired floating point format (fp4, fp6, fp8, fp16, bf16, fp32) as described above, as commanded by fused mixed precision floating point instructions described herein.

A normalizer can also be included for implementations that do not flush denormals that are close to zero.

FIG. 16 is just one of many possible example implementations. For more information concerning legacy hardware calculation in prior designs, see for example US20240160406; U.S. Pat. No. 7,428,566; WO2006053173; US20140188963.

Note: A Word About Floating Point and Precision

Like the “scientific notation” many of us learned in high school, high precision numbers can be represented using “floating point” representations. See e.g., See IEEE 754-2008 revision “IEEE Standard for Floating-Point Arithmetic” IEEE Std 754™-2019, which defines the following binary interchange formats including 32-bit floating point or “fp32” that represents the value using 32 binary bits (and see also FIG. 10):

TABLE 3.5
Binary interchange format parameters

| Parameter | binary16 | binary32 | binary64 | binary128 | binary{k} (k ≥ 128) |
|---|---|---|---|---|---|
| k, storage width in bits | 16 | 32 | 64 | 128 | multiple of 32 |
| p, precision in bits | 11 | 24 | 53 | 113 | k-round(4 × log₂(k)) + 13 |
| emax, maximum exponent e | 15 | 127 | 1023 | 16383 | 2^{(k-p-l)} − 1 |

Encoding parameters

| | | | | | |
|---|---|---|---|---|---|
| bias, E-e | 15 | 127 | 1023 | 16383 | emax |
| sign bit | 1 | 1 | 1 | 1 | l |
| w, exponent field width in bits | 5 | 8 | 11 | 15 | round(4 × log₂ (k)) − 13 |
| t, trailing significand field | 10 | 23 | 52 | 112 | k − w − l |
| width in bits | | | | | |
| k, storage width in bits | 16 | 32 | 64 | 128 | l + w + l |

fp32 (“Single Precision”)(32-bit) uses 1 bit for sign, 8 bits for exponent, and 23 bits for mantissa. The radix point floats via the exponent, but the length of the mantissa is fixed so it is often referred to as a fixed-precision floating point format. It is the standard for general computing and AI training due to high accuracy, allowing representation of a wide range of values.
fp16 (“Half Precision”)(16-bit) uses 1 bit for sign, 5 bits for exponent, and 10 bits for mantissa. Again, the radix point floats via the exponent, but the length of the mantissa is fixed so it is often referred to as a fixed-precision floating point format. fp16 has a lower (or “narrower”) fixed precision than fp32 format. fp16 is used in AI to reduce memory consumption and speed up computations, often on GPU Tensor Cores, though it is more prone to rounding errors or numerical instability than fp32.
bf16 (Brain Floating Point) is another 16-bit fixed precision floating point format that offers the same range as fp32 but with lower precision, making it more robust than fp16 during training. Bfloat16 (Brain Floating Point, or bf16) is a 16-bit floating-point numerical representation developed by Google Brain to accelerate machine learning algorithms. It was designed to offer the same dynamic range as standard 32-bit IEEE single-precision floating-point numbers (fp32) while reducing memory usage by half. bf16 is supported on NVIDIA GPUs including A100, H100, and Blackwell, often utilized alongside Tensor Cores for mixed-precision training. This format holds 1 sign bit, 8 exponent bits (same exponent range as fp32) and 7 fraction bits. The significand length is fixed, so this is another fixed-precision floating point format with less precision than fp16 but similar range to fp32.

Just as multiplying 16,684×3,577 will take you longer to calculate than multiplying 4×5, hardware circuits designed to multiply short numbers can calculate faster than ones designed to multiply longer numbers. To save time, modern numerical calculating arithmetic logic hardware circuitry is often designed to alternatively calculate using precision lower (“narrower”, due to the smaller number of bits in the representation) than fp32, such as 16-bit floating point (“fp16”, see above) or sometimes even lower (narrower) precision such as 8-bit floating point (“FP8”). Using such lower precision calculations significantly reduces memory usage and increases throughput by reducing computation time, thereby reducing power requirements and heat output.

However, as in other contexts, reducing precision in the interest of higher speed has the potential to pose significant precision downsides and produce large errors. As explained above, this is particularly true in implementations of SoftMax and Flash Attention.

Neural network can make use of even smaller precisions—often by factoring a scaling factor and a bias across a subset of the tensor dimensions. The Open Compute Project (OCP) has been active to define and standardize the use of such small formats. It published a standard for microscaling formats at “OCP Microscaling Formats (MX) Specification” Version 1.0 (September 2023). That standard defines Microscaling (“MX”)-compliant data formats, their binary interchange formats, and basic operations on them. It specifies concrete MX-compliant 8-bit, 6-bit, and 4-bit data formats. Additionally, it defines the binary encodings for 6-bit floating-point (FP6), 4-bit floating-point (FP4), and 8-bit integer (INT8) numbers. A summary is shown below:

TABLE 1
Format names and parameters of concrete MX-compliant formats.

| Format | Element | Element | Scaling Block | Scale Data | Scale |
|---|---|---|---|---|---|
| Name | Data Type | Bits (d) | Size (k) | Type | Bits (w) |
| MXFP8 | FP8 (ESM2) | 8 | 32 | E8M0 | 8 |
| | FP8 (E4M3) | | | | |
| MXFP6 | FP6 (E3M2) | 6 | 32 | E8M0 | 8 |
| | FP6 (E2M3) | | | | |
| MXFP4 | FP4 (E2M1) | 4 | 32 | E8M0 | 8 |
| MXINT8 | INT8 | 8 | 32 | E8M0 | 8 |

These MX formats are block fixed-precision floating point (or integer) formats. When stored in a block, these MX formats share a single scaling factor (an E8M0 exponent-only value). The elements themselves are (see “Element Data Type” in the table above) are conventional minifloats each having a fixed number of exponent bits and mantissa bits. Each element is thus a fixed-precision floating point representation (or fixed-point, in the INT8 case).

Another example of a fixed-precision floating point representation is the Tensor Float 32 (TF32) format, introduced with the Ampere architecture (A100). TF32 combines the high dynamic range of fp32 with the precision of fp16. See e.g., U.S. Pat. No. 2,475,189; P1; U.S. Pat. No. 2,204,897; P1; Kharya, “TensorFloat-32 in the A100 GPU Accelerates AI Training, HPC up to 20×” (NVIDIA May 14, 2020) and Gupta, “What's the Difference Between Single-, Double-, Multi- and Mixed-Precision Computing?” (NVIDIA Nov. 15, 2019).

All patents and publications cited above are incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A neural network processor comprising:
a hardware calculator that receives a vector of logits; exponentiates each element of the vector; sums exponentiated values to provide a sum; and divides each exponentiated element by the sum to produce a probability distribution of results each of which are between 0 and 1 and all of which together sum to 1,
wherein the hardware calculator includes a hardware instruction decoder configured to decode a single instruction call controlling hardware to (a) compute a value in first precision floating point and (b) convert the computed first precision floating point value to a second precision floating point value having a second floating point precision different than the first precision floating point.

2. The neural network processor of claim 1 wherein the hardware instruction decoder is configured to decode one of (a) a mixed precision addition/subtraction operation code, or (b) a mixed precision multiply operation code, or (c) a mixed precision multiply-add operation code, configured to compute a single precision floating point value and convert the single precision floating point value to a half precision floating point value.

3. A hardware microinstruction decoder configured to decode a single instruction that performs an operation on results of a first math instruction at a first floating point fixed precision and converts the results to a second floating point fixed precision less than the first floating point fixed precision.

4. A processing circuit comprising:
an arithmetic logic circuit configured to produce a floating point difference by performing a subtraction based on a first floating point operand at a first floating point precision;
a floating point precision converting circuit connected to the arithmetic logic circuit and configured to convert the floating point difference to a second floating point precision difference having a second floating point precision different from the first floating point precision; and
a storage connected to the floating point precision converting circuit and configured to pack the second floating point precision difference with at least one other floating point value in a packed storage format,
wherein the processing circuit is configured to perform both the subtraction and the floating point precision conversion in response to a single instruction.

5. The processing circuit of claim 4 wherein the second floating point precision is fp16 or bf16 or fp8 or fp6 or fp4.

6. The processing circuit of claim 4 wherein the second floating point precision is no more than half of the first floating point precision.

7. The processing circuit of claim 4 further comprising:
a scaling circuit connected to the floating point precision converting circuit and/or the storage and configured to scale the packed precision-converted differences;
an exponentiation circuit connected to the scaling circuit and/or the storage and configured to apply an exponential operation to the scaled precision-converted differences to produce results at the first floating point precision; and
a summer connected to the exponentiation circuit and/or the storage and configured to sum results the exponentiation circuit produces to generate a sum at the first floating point precision.

8. The processing circuit of claim 5 further comprising:
a divider circuit connected to receive the sum and to calculate exponent reciprocals of the sum at the second floating point precision.

9. The processing circuit of claim 7 further comprising:
a quantizing circuit configured to quantize pairs of calculated exponent reciprocals to provide reduced floating point precision results.

10. The processing circuit of claim 9 further comprising:
a further scaling circuit configured to reduce precision of the calculated exponent reciprocals to a third floating point precision less than the first floating point precision and less than the second floating point precision.

11. The processing circuit of claim 4 wherein the arithmetic logic circuit is configured to flush output subnormals to 0.

12. An instruction decoder configuring arithmetic logic circuitry to calculate probability distribution function parameters, the instruction decoder configured to perform operations comprising:
decode a first fused floating point instruction commanding (a) computation of a delta between each floating point value of a probability distribution function input data block at a first floating point precision and a maximum value of the input data block at the first floating point precision, (b) conversion of computed deltas to a second floating point precision different from the first floating point precision, and (c) packing converted computed deltas pairwise; and
decode a second fused floating point instruction commanding scaling by a specified exponential-only scaling factor to produce floating point values divided by the specified exponential-only scaling factor and further converted to a reduced precision.

13. The instruction decoder of claim 12 wherein the probability distribution function comprises SoftMax and/or Flash Attention.

14. The instruction decoder of claim 12 wherein the second floating point precision comprises fp16 or bf16 or fp8 or fp6 or fp4.

15. The instruction decoder of claim 12 wherein the instruction decoder is further configured to decode an instruction that sums two parallel accumulators with two exponentials of the second floating point precision.

16. Computing circuitry comprising:
an input circuit configured to accept first and second input values and an input scale factor in exponent format; and
a scaling/dividing circuit that divides the first and second input values by the input scale factor in exponent format and then converts scaled outputs into a narrower format,
wherein the input circuit and the scaling/dividing circuit both operate in response to the same single instruction call.

17. The computing circuitry of claim 16 wherein the scaling/dividing circuit is configured to flush input subnormals.

18. The computing circuitry of claim 16 wherein the scaling/dividing circuit is configured to selectively perform block quantization to a selected one of microscaling FP4/FP6/FP8 formats based on parameters of the same instruction.

19. The computing circuitry of claim 16 wherein the exponent format is E8.

20. The computing circuit of claim 16 further comprising a matrix multiplication circuit configured to perform a matrix-multiply-accumulate operation on the converted quotients.

21. The computing circuit of claim 16 wherein the input scale factor is factored out as a common scaling factor from a set of operands.

22. The computing circuit of claim 16 further comprising an output circuit that packs the converted quotients such that the computing circuit fuses the division by the input scaling factor with conversion to the narrower format(s) in the single instruction.

23. The computing circuit of claim 16 wherein the scaling/divider circuit generates outputs with different exponents.

24. Method performed by at least one processor accelerated by hardware circuits, comprising:
commanding, with a first fused mixed precision floating point instruction call, computing deltas between each value of an input data block and a maximum value of the input data block, converting resulting differences into a reduced precision, and storing the resulting differences in a packed format;
commanding, with a second instruction call, exponentiation by scaling the stored resulting differences;
commanding, with a third instruction call, applying two to the power of x function to produce exponentials;
commanding, with a fourth, fused mixed precision instruction call, summing the exponentials to produce a sum;
commanding, with a fifth instruction call, reciprocating the summed exponentials to form a denominator; and
commanding, with a sixth instruction call, multiplying each exponential by the denominator to produce results.

25. The method of claim 24 further including:
commanding, with a seventh, fused mixed precision floating point instruction call, scaling of the results; and
commanding, with an eighth fused mixed precision floating point instruction call, further scaling of the scaled results by an inputted common scale factor.

26. The method of claim 24 further including flushing output subnormals to 0.

27. An instruction set architecture (ISA) supported by instruction decoding circuitry capable of decoding:
a first mixed precision fused addition/subtraction and fixed floating point precision conversion instruction,
a second mixed precision fused multiply and fixed floating point precision conversion instruction,
a third mixed precision half-precision fused multiply-add and fixed floating point precision conversion instruction,
a fourth mixed precision single precision fused multiply-add instruction providing single to half fixed floating point precision conversion,
a fifth mixed precision fused half-precision floating-point multiplication and fixed floating point precision conversion instruction, and
a sixth mixed precision fused scaling and fixed floating point precision conversion instruction.

28. A non-transitory memory device storing code that when executed performs computations, the stored code comprising:
a first mixed precision fused addition/subtraction and fixed floating point precision conversion instruction,
a second mixed precision fused multiply and fixed floating point precision conversion instruction,
a third mixed precision half-precision fused multiply-add and fixed floating point precision conversion instruction,
a fourth mixed precision fused multiply-add instruction providing single to half fixed floating point precision conversion,
a fifth mixed precision fused half-precision floating-point multiplication and fixed floating point precision conversion instruction, and
a sixth mixed precision fused scaling and fixed floating point precision conversion instruction.
